(19) United States
(12) Patent Application Publication
(10) Pub. No.: US 2008/0178961 A1
(43) Pub. Date: Jul. 31, 2008

(54) LIQUID CRYSTAL PLATE, LIQUID CRYSTAL INJECTION APPARATUS AND LIQUID CRYSTAL INJECTION METHOD

(75) Inventors: Terunobu Iio, Kawasaki (JP); Takanori Kondo, Kawasaki (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KAWASAKI (JP)

(21) Appl. No.: 12/018,812

(22) Filed: Jan. 24, 2008

(30) Foreign Application Priority Data
Jan. 29, 2007 (JP) 2007-018121

(51) Int. Cl. G02F 1/1341

(52) U.S. Cl. 141/59; 349/189; 141/7

(57) ABSTRACT

A liquid crystal plate for storing a liquid crystal material for simultaneously injecting it into a plurality of liquid crystal panels and liquid crystal injection apparatus and method using such liquid crystal plate are disclosed. The liquid crystal plate has a recess for storing the liquid crystal material and a pair of raised members such as ribs, baffles or the like at both end portions of the recess in parallel with the outermost liquid crystal panels. The raised members have the height at least equal to the top surface of the liquid crystal material filled in the recess for maintaining the liquid crystal characteristics of the liquid crystal material injected into the plurality of liquid crystal panels substantially uniform regardless of the location in a cassette.

### INCORPORATION BY REFERENCE

This application is based upon and claims the benefit of priority from Japanese patent application no. 2007-018121, the disclosure of which is incorporated herein in its entirety by reference.

### FIELD OF INVENTION

The present invention relates to a liquid crystal plate, a liquid crystal injection apparatus and a liquid crystal injection method, more specifically to a liquid crystal plate having a recess to store a liquid crystal material for simultaneously injecting it into a plurality of liquid crystal panels in a cassette and liquid crystal injection apparatus and method that use such liquid crystal plate suitable for simultaneously injecting a liquid crystal material of uniform composition into a plurality of liquid crystal panels.

### RELATING ART

A liquid crystal display device is fabricated by assembling a liquid crystal panel (or a liquid crystal cell) that comprises a pair of substrates having electrodes and an orientation film formed on the inner surfaces and jointed together by way of a frame-like seal member, vacuum injecting a liquid crystal material inside the liquid crystal panel by a vacuum injection method and then sealing a liquid crystal injection inlet with a sealing member made from suitable resin. The vacuum injection method comprises the steps of setting in a vacuum container a plurality of liquid crystal panels each having a sealing material provided with a liquid crystal inlet and a liquid crystal plate for storing a liquid crystal material, dipping the liquid crystal inlets of the liquid crystal panels into the liquid crystal material while the vacuum container is held in vacuum, and subsequently releasing the vacuum to return the container to the atmospheric pressure, thereby forcing the liquid crystal material to be injected into the liquid crystal panels through the respective inlets by the pressure differences between outside and inside the liquid crystal panels as well as the capillary phenomenon of the liquid crystal panel (see pages 2-3 in JP58-49853B1 that is referred to as a Patent Document 1 below).

Firstly, a structure of a conventional liquid crystal plate and a liquid crystal injection method will be described hereunder with reference to FIGS. 9-11. FIG. 9 is a simplified illustration of a conventional liquid crystal plate. FIG. 10 is a cross section view of the liquid crystal plate of FIG. 9 along the line C-C′. FIG. 11 is an illustration of liquid crystal panels to be set to the liquid crystal plate for describing how plural liquid crystal display panels are simultaneously fabricated by injecting the liquid crystal material filled in a recess in the liquid crystal plate.

With reference to FIGS. 9-11, descriptions will be made on the construction of the liquid crystal plate and the method of injecting the liquid crystal material that are used in a conventional liquid crystal injection apparatus. As best shown in FIGS. 9 and 10, the liquid crystal plate 1 is formed with a recess 2 for storing the liquid crystal material and is generally made from any suitable liquid crystal material repellent material such as polytetrafluoroethylene (PTFE that is commonly known as “Teflon” (registered trademark)) or the like. As a result, when the liquid crystal material 4 is filled in the recess 2 in the liquid crystal plate 1, the top surface of the liquid crystal material 4 tends to be raised beyond the upper surface of the liquid crystal plate 1 due to the liquid crystal material repellent characteristic of the liquid crystal plate 1 and the surface tension of the liquid crystal material 4 (see the dotted line in FIG. 10). When liquid crystal panels 3 are set to the liquid crystal plate 1 for dipping them into the liquid crystal material 4, the liquid crystal material 4 is injected into and filled in the liquid crystal panels 3 through injection inlets 3a that are formed at the bottom ends of the liquid crystal panels 3.

Now, a process of injecting the liquid crystal material 4 into the liquid crystal panels 3 will be described hereunder. The liquid crystal plate 1 with the liquid crystal material 4 filled in the recess 2 is placed on a lift that is accommodated in a vacuum container in such a manner to go up and down. The lift is moved upwardly toward the liquid crystal panels 3 that are held above the liquid crystal plate 1 so that the liquid crystal material 4 in the recess 2 touches the injection inlets 3a at the bottom ends of the liquid crystal panels 3 for dipping. As a result of the dipping, a small amount of liquid crystal material 4 is sucked into the liquid crystal panels 3 through their injection inlets 3a by the capillary phenomenon.

It is to be noted here that when the liquid crystal panels 3 are dipped in the liquid crystal material 4 in the recess 4, the surface of the liquid crystal material 4 is lifted up by the surface tension and the liquid crystal material 4 is collected at the central portion of the recess 2 where the liquid crystal panels 3 are located. On the other hand, the surface 4a of the liquid crystal material 4 is low at both end portions of the recess 2. This results in insufficient dipping of the liquid crystal material 4 for the liquid crystal panels 3 located at both end portions or volatile portion of the liquid crystal material 4 may predominate for the liquid crystal panels 3 at both end portions (see FIG. 11).

If vacuum is released to return the pressure inside the evacuation container to the atmospheric pressure under the above condition, the liquid crystal material 4 is sequentially injected into the liquid crystal panels 3 until these panels 3 are filled with the liquid crystal material 4 by utilizing both of the pressure difference and the capillary phenomenon. Consequently, as described hereinabove, the liquid crystal material 4 of minimum change in its composition is injected into the liquid crystal panels 3 at the center portions of a cassette comprising a plurality of liquid crystal panels 3. On the other hand, however, the liquid crystal material of a larger change in its composition is injected into the liquid crystal panels 3 at or near the both ends of the cassette, thereby causing considerable changes in characteristics of the liquid crystal material in the plurality of liquid crystal panels 3 that are fabricated simultaneously.

However, the vacuum injection method as disclosed in the above Patent Document 1 has the following drawbacks. Although volatile amount of the liquid crystal material in the liquid crystal panels in the evacuation container may be reduced by optimizing the size of and the degree of vacuum in the evacuation container, the size of the evacuation container for accommodating the liquid crystal panels becomes larger as the size of the liquid crystal panels to be fabricated increases. This means that longer time is required for evacuating the evacuation container, thereby some compositions in the liquid crystal material tend to evaporate and significantly deteriorating liquid crystal performances such as response time and the like of the fabricated liquid crystal display devices.

Moreover, even if the degree of vacuum may be optimized, it is impossible to improve uniformity of the fabricated liquid crystal panels due to locations of the liquid crystal panels that are set in the evacuation container or the liquid crystal plate. That is, the volatile amount of compositions in the liquid crystal material to be injected into liquid crystal panels that are set to outer locations is larger as compared to that of liquid crystal panels that are set to inner locations. Proposed as the countermeasure to this problem is to provide the same liquid crystal material as the one to be injected into the liquid crystal display devices within the same evacuation container, thereby supplementing the volatile components (see pages 3-4 in JP9-80450B1 that is referred to as a Patent Document 2 below).

However, the liquid crystal injection method as disclosed in the Patent Document 2 encounters the following problems:

A first problem is that additional supplementary liquid crystal material must be prepared and placed in the evacuation container. A second problem is the need of a longer time for degassing the gases dissolved in the liquid crystal material because more liquid crystal material is used. A third problem is the volatile amount of liquid crystal injected into the liquid crystal panels differs depending upon their location set in the liquid crystal plate. That is, the volatile amount of the liquid crystal material to be injected into liquid crystal panels set to outer locations in the liquid crystal plate is still larger as compared to that into liquid crystal panels set to inner locations.

Although the above first and second problems may be improved to some extent by optimizing the size of and the degree of vacuum in the evacuation container, it is impossible to improve the above third problem because the tendency of larger volatile amount of the liquid crystal material injected into the liquid crystal panels set to outer locations than that to the center part in the liquid crystal plate remains unchanged and cannot be improved even if the degree of vacuum is optimized.

It is to be noted that the degassing of the liquid crystal material in the vacuum injection method is performed while the liquid crystal material is filled in a recess or groove that is formed in the liquid crystal plate. In the vacuum degassing process of the liquid crystal material, any volatile compositions tend to evaporate from the surface layer of the liquid crystal material that is filled in the liquid crystal plate, thereby developing a consistency gradient in the depth direction of the liquid crystal material. This means that there are larger consistency changes of low viscosity components in the surface layer of the liquid crystal material, while less change in the bottom area in the recess.

If liquid crystal panels are dipped into the liquid crystal plate under such condition, the surface of the liquid crystal material tends to be lifted by the surface tensile and the liquid crystal tends to be collected to the central part. On the other hand, the surface of the liquid crystal material tends to go down, thereby predominating by the evaporated area.

Now, allowing the evacuation container to return to the atmospheric pressure condition, the liquid crystal panels are filled with the liquid crystal material. The liquid crystal panels at the central part in the cassette are filled with the liquid crystal material of minimum change in its composition. On the other hand, however, the liquid crystal panels at or near the end parts in the cassette are willed with the liquid crystal of larger change in its composition. This means that characteristics and performances of the liquid crystal injected into the liquid crystal panels tend to vary depending upon the location of the liquid crystal panels that are set to the liquid crystal plate.

### SUMMARY OF THE INVENTION

In consideration of the abovementioned circumstances, it is an object of the present invention to provide a liquid crystal plate, a liquid crystal injection apparatus and a liquid crystal injection method in which evaporation of the liquid crystal material can be minimized for enabling to simultaneously fabricate a plurality of liquid crystal panels (liquid crystal cells) by injecting liquid crystal material of uniform composition into a plurality of liquid crystal panels regardless of their locations to be set to the liquid crystal plate.

In other words, the present invention eliminates or minimizes the drawback of changing characteristics of the liquid crystal injected into the liquid crystal panels when the vacuum inside the vacuum container is released to return to the atmospheric pressure. That is, the liquid crystal material of minimum composition change is injected into the liquid crystal panels at central locations in the cassette, while injecting the liquid crystal material of larger composition change is injected into the liquid crystal panels at or near the end locations in the cassette. For this end, the present invention provides a rib structure (raised members) at both end portions of the recess in the liquid crystal plate to act as banks for the raised liquid crystal material, thereby preventing the surface of the liquid crystal material for the liquid crystal panels at both ends from lowering due to the surface tension.

Moreover, the distance or gap between the ribs at both ends of the recess in the liquid crystal plate and the liquid crystal panels at both end portions is adjusted to substantially equal to the distance between other adjacent liquid crystal panels, thereby minimizing the surface areas of the liquid crystal material to be exposed to the air at both end portions and in turn decreasing volatile amount of the liquid crystal material.

Alternatively, a baffle structure (raised members) is employed at the both end portions of the recess in the liquid crystal plate to act as shield plates for allowing the liquid crystal material at the bottom area to be injected in priority into the liquid crystal panels at both ends, thereby preventing the surface of the liquid crystal material at both end portions from lowering.

And the distance or gap between the baffles at both ends of the recess in the liquid crystal plate and the liquid crystal panels at the both ends is adjusted to substantially equal to those of the other adjacent liquid crystal panels, thereby decreasing the surface area of the liquid crystal material exposed to the air at the both end portions and in turn minimizing volatile liquid crystal material.

The liquid crystal plate, the liquid crystal injection apparatus and the liquid crystal injection method according to the present invention exhibit the following practical advantages:

The provision of the ribs (raised members) acting as banks for the raised portions of the liquid crystal material at both ends of the recess in the liquid crystal plate or the baffle structure having a baffle acting as a shielding plate at each end of the recess helps to achieve uniform liquid crystal characteristics of a plurality of liquid crystal panels that are fabricated simultaneously by maintaining volatile amount of liquid crystal material to be injected into the liquid crystal panels (liquid crystal cells) constant regardless of their locations to be set to the liquid crystal plate.

Moreover, the provision of the sliding mechanism for sliding the ribs or the baffles helps to maintain the distance between the rib or the baffle and the liquid crystal panels (liquid crystal cells) at the both ends substantially equal to those between the adjacent other liquid crystal panels depending upon the number of liquid crystal panels (liquid crystal cells) to be fabricated simultaneously, thereby reducing the surface area of the liquid crystal material to be exposed to the air and thus making the liquid crystal material less volatile and reducing cost.

### BRIEF DESCRIPTION OF DRAWINGS

Now, referring to the accompanying drawings:

FIG. 1 is a simplified illustration of a first exemplary embodiment of the liquid crystal plate according to the present invention;

FIG. 2 is a cross section view of the liquid crystal plate in FIG. 1 along the line A-A′;

FIG. 3 is a cross section view of the liquid crystal plate in FIG. 1 to show how plural liquid crystal panels are set;

FIG. 4 is a simplified illustration of a second exemplary embodiment of the liquid crystal plate according to the present invention;

FIG. 5 is a cross section view of the liquid crystal plate in FIG. 4 along the line B-B′;

FIG. 6 is a cross section view of the liquid crystal plate in FIG. 4 to show how plural liquid crystal panels are set;

FIG. 7 is a simplified illustration of a modification of the first exemplary embodiment of the liquid crystal plate as shown in FIGS. 1-3 in which a slide mechanism is provided for adjusting the length or width of the recess depending upon the number of liquid crystal panels to be fabricated simultaneously;

FIG. 8 is a simplified illustration of a modification of the second exemplary embodiment of the liquid crystal plate as shown in FIGS. 4-6 in which a slide mechanism is provided for adjusting the length or width of the recess depending upon the number of liquid crystal panels to be fabricated simultaneously;

FIG. 9 is a perspective view of a conventional liquid crystal plate;

FIG. 10 is a cross section view of the liquid crystal plate in FIG. 9 along the line C-C′ and also showing a liquid crystal material filled in a recess in the liquid crystal plate; and

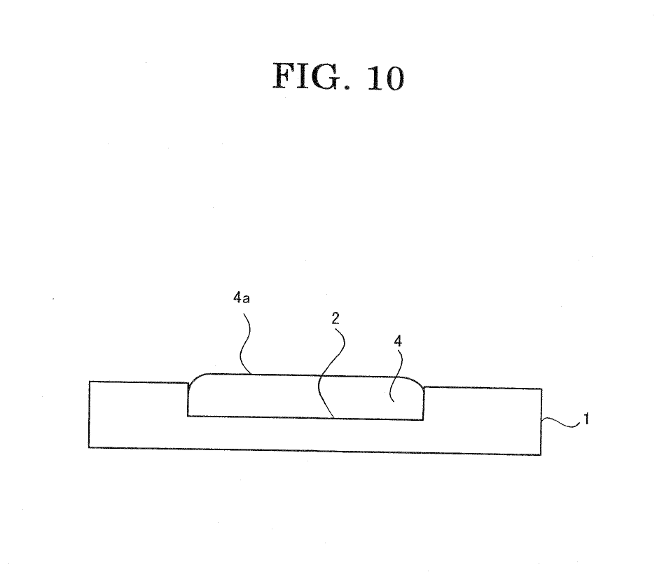

FIG. 11 is a cross section view of the liquid crystal plate in FIG. 9 in which a plurality of liquid crystal panels are dipped in the liquid crystal material filled in the recess.

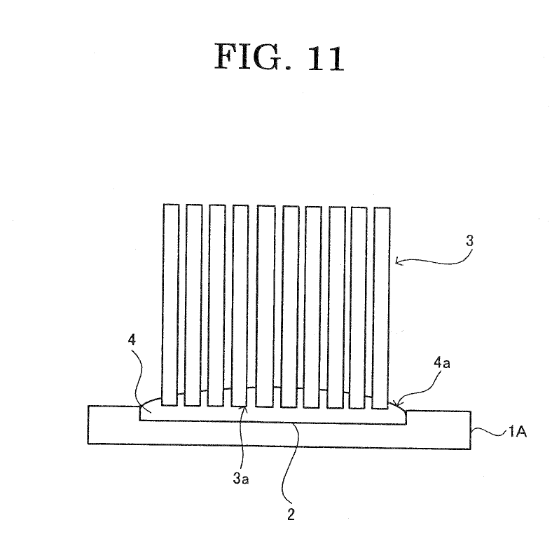

### DETAILED DESCRIPTION OF EXEMPLARY EMBODIMENTS

Now, exemplary embodiments of the liquid crystal plate, the liquid crystal injection apparatus and the liquid crystal injection method according to the present invention will be described hereunder in detail with reference to the accompanying drawings.

### Features of the Present Invention

Features of the present invention will be described before giving detailed description. Raised members such as a rib structure or a baffle structure are provided at both end portions of the recess in the liquid crystal plate. Even if highly volatile liquid crystal material may be used, the raised members (i.e., the rib structure or the baffle structure) help to uniformly inject such liquid crystal material into a plurality of liquid crystal panels constituting a cassette regardless of the location of each liquid crystal panel. Moreover, it is also possible to provide the liquid crystal plate that reduces volatile amount of the liquid crystal material.

### Construction of the Exemplary Embodiments

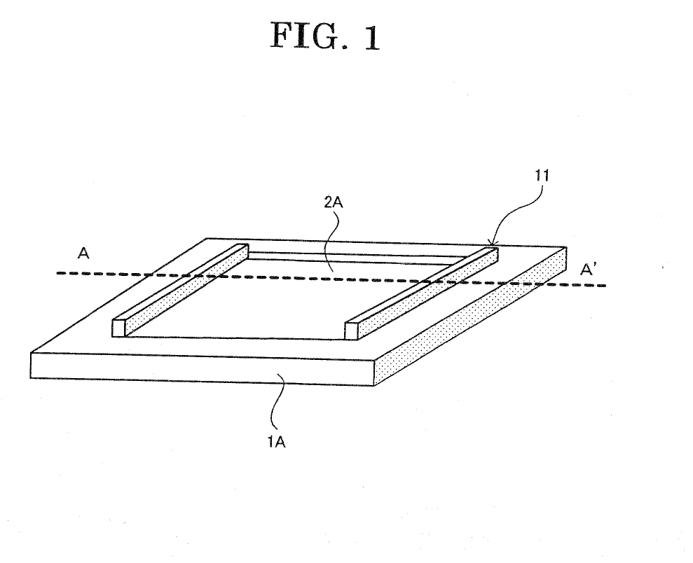

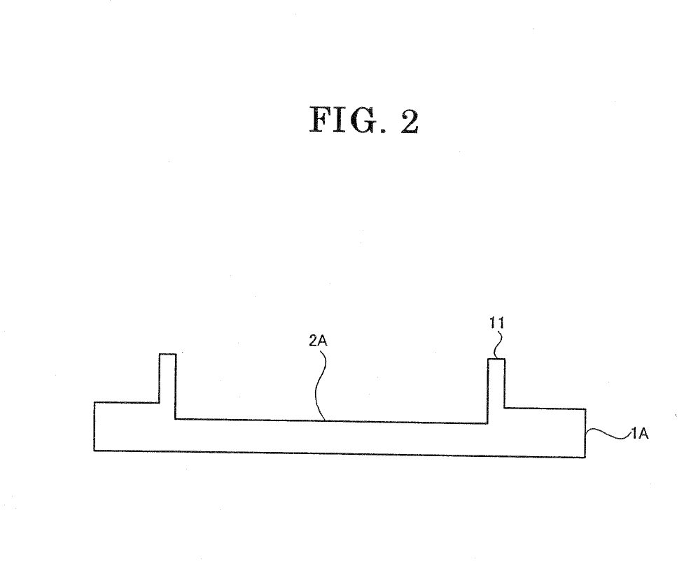

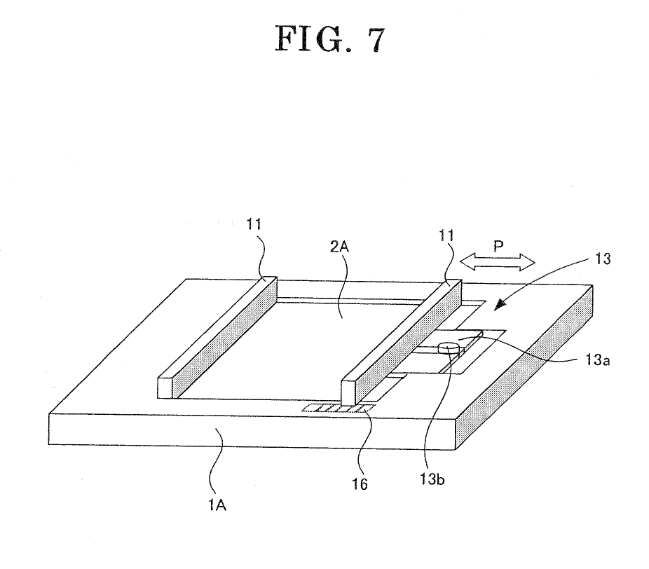

As contrast to the foregoing, a first exemplary embodiment of the liquid crystal injection apparatus according to the present invention as shown in FIGS. 1-3 uses a liquid crystal plate 1A for injecting the liquid crystal material 4 into the liquid crystal panels 3 by the vacuum injection method. The liquid crystal plate 1A differs from the conventional liquid crystal plate 1 in FIG. 7 in the provision of ribs 11 at both end portions of the recess 2A in the liquid crystal plate 1A in the direction of arrangement of the liquid crystal panels 3 or along the surfaces of the outermost liquid crystal plates 3. It is to be noted that the recess 2A is provided with a coating of, for example, a fluoric compound that repels the liquid crystal. Preferably, the ribs 11 have the height higher than the top surface of the raised liquid crystal material 4 and act as banks for the raised liquid crystal material 4.

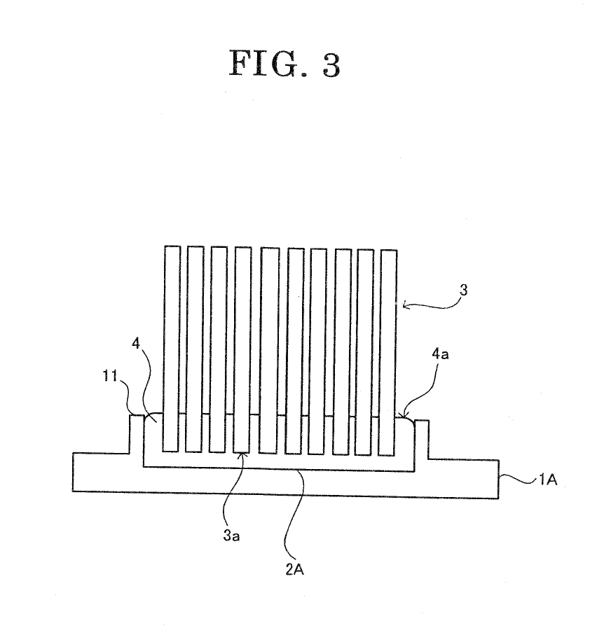

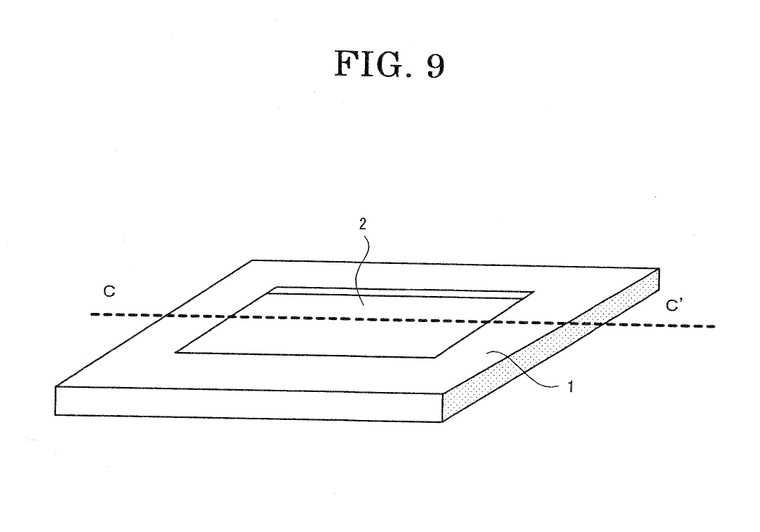

As a result, the surface 4a of the liquid crystal material 4 that is filled in the recess 2A is raised at both end portions thereof because of the surface tension with the ribs 1 as best shown in FIG. 3. This prevents the surface of the liquid crystal material 4 from lowering at both end portions unlike the case in the abovementioned conventional liquid crystal plate as shown in FIG. 9.

Additionally, the space or gap between the ribs 11 at both end portions of the recess 2A and the outermost liquid crystal panels 3 is held substantially equal to that between the other adjacent liquid crystal panels (or liquid crystal cells) 3, thereby enabling to reduce the surface area of the liquid crystal material 4 exposed to the air.

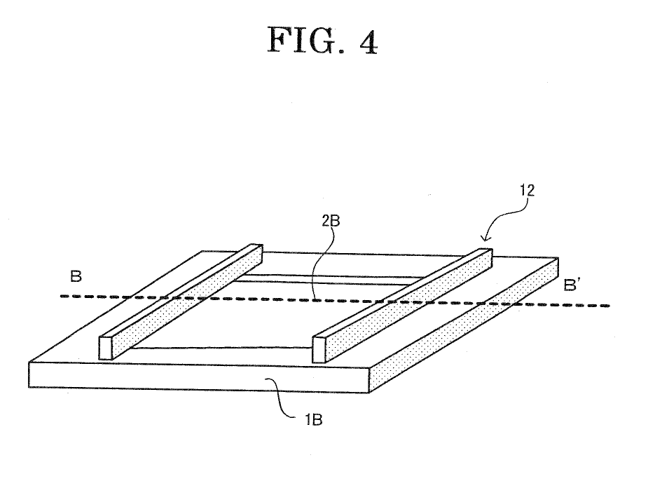

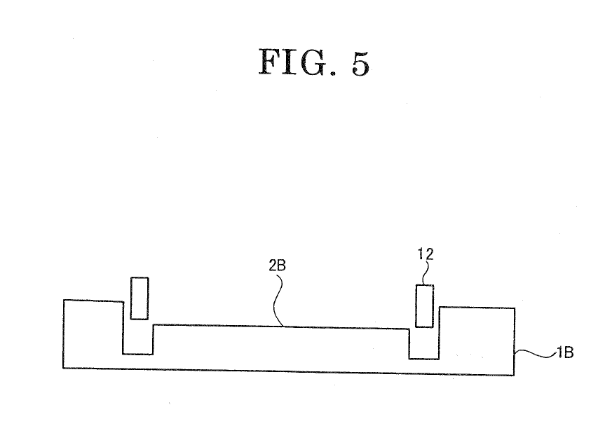

Alternatively, a second exemplary embodiment of the liquid crystal injection apparatus according to the present invention employs a baffle structure liquid crystal plate 1B to be used for injecting the liquid crystal material into liquid crystal panels 3 by the vacuum injection method as shown in FIGS. 4-6. That is, deep trenches are formed in the recess 2B in the liquid crystal plate 1B at both end portions in the direction of arrangement of the liquid crystal plates 3 or along the surface of the outermost liquid crystal panels 3 and baffles 12 higher than the raised surface 4a of the liquid crystal material 4 held in the recess 4 are provided above the trenches for acting as shield plates. This particular configuration allows the liquid crystal materials 4 at the bottom areas of the baffles 12 in the liquid crystal plate 1B is injected in priority into the liquid crystal panels 3 at both end portions.

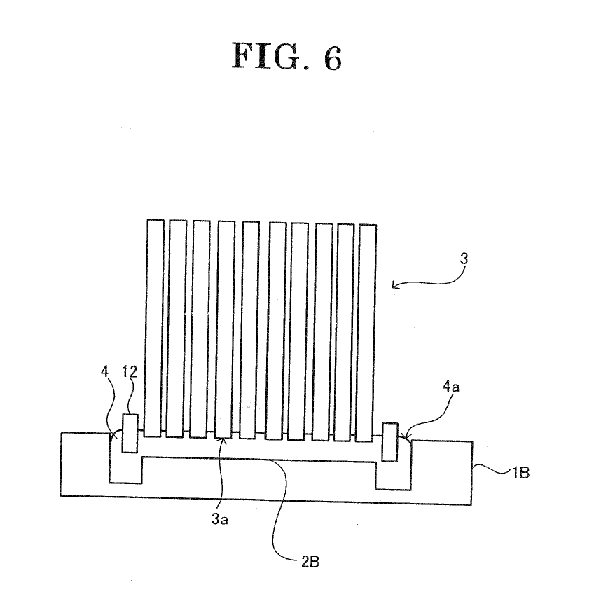

Due to the above configuration, the surface 4a of the liquid crystal material 4 stored at the both end portions in the recess 2B enables to be injected in priority into the liquid crystal panels 3 at the both end portions and also to be raised by the surface tension with the baffles 12 as shown in FIG. 6, thereby preventing the surface of the liquid crystal material from lowering unlike the case in the conventional liquid crystal plate as shown in FIG. 9.

Again, it is possible and preferable to maintain the space or gap between the baffles 12 provided at both ends of the recess 2B and the outermost liquid crystal panels 3 substantially equal to that between the other adjacent liquid crystal panels (or liquid crystal cells) 3 similar to the rib structure as shown in FIGS. 1-3, thereby reducing the surface area of the liquid crystal material 4 exposed to the air.

### Other Exemplary Embodiments

Now, descriptions will be made on exemplary embodiments having an adjusting mechanism of the length (or width) of the recess in the liquid crystal plate to be used in a liquid crystal injection apparatus for simultaneously fabricating variable number of liquid crystal panels (or liquid crystal cells) 3 in a cassette by dipping them into the liquid crystal material. FIG. 7 is a simplified illustration of a modification of the first exemplary embodiment as shown in FIGS. 1-3, in which the location of one of the ribs (the right side rib in the shown embodiment) 11 in the liquid crystal plate 1A is made slidable (or adjustable) depending upon the number of liquid crystal panels 3 in the cassette, thereby making the size or width of the recess 2A in the liquid crystal plate 1A adjustable.

As shown in FIG. 7, the liquid crystal plate 1A is provided with a slide mechanism 13 for sliding one of the ribs (e.g., the right side rib) 11. That is, the right side rib 11 is configured to slide horizontally (i.e., in the left-to-right direction in FIG. 7 or the direction of holding the plural liquid crystal panels) depending upon the number of liquid crystal panels 3 that are simultaneously dipped into the liquid crystal material in the recess 2A in such a manner that the distance or space between the ribs 11 and the outermost liquid crystal panels 3 is maintained substantially equal to the space between the other adjacent liquid crystal panels (liquid crystal cells) 3. This enables to reduce the surface area of the liquid crystal material 4 exposed to the air. The slide mechanism 13 comprises the upright rib 11 and a horizontal plate 13a extending horizontally in the direction away from the other (or left rib) at the bottom of the rib 11. Preferably, the right side rib 11 can be fixed to a desired horizontal position by a screw 13b. Also, a scale 16 maybe provided on the upper surface of the liquid crystal plate 1A adjacent to the sliding rib 11 for enabling the operator to adjust it at proper position.

As a result, consumption of the liquid crystal material 4 can be optimized, thereby reducing the fabrication cost by minimizing waste of the expensive liquid crystal material 4.

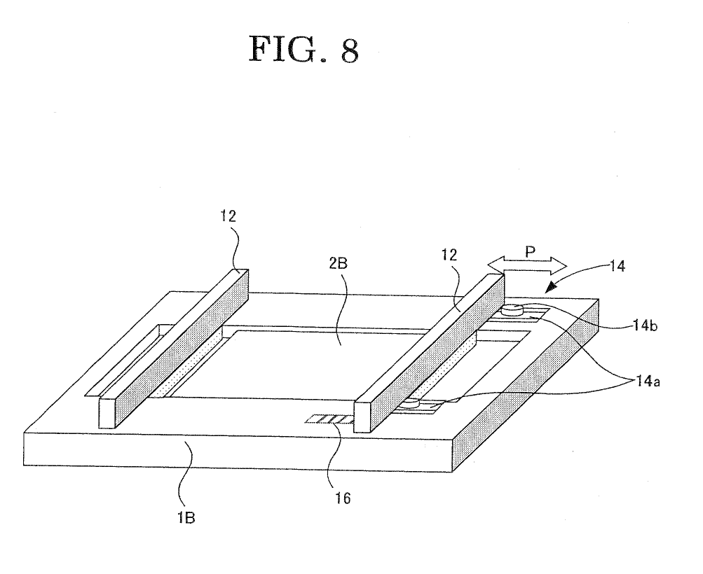

On the other hand, FIG. 8 is a simplified illustration of a modification of the second exemplary embodiment of the liquid crystal plate 1B of a baffle structure as shown in FIGS. 4-6. Again, the location of the baffles 12 is made slidable or adjustable depending upon the number of liquid crystal panels 3 in the cassette, thereby making the size (or width) of the recess 2B in the liquid crystal plate 1B adjustable.

The provision of a sliding mechanism 14 for sliding the baffles 12 in the liquid crystal plate 1B allows to horizontally slide one of the baffles 12 depending upon the number of liquid crystal panels 3 to be simultaneously dipped into the liquid crystal material 4 in the recess 2B so that the space or gap between the baffles 12 and the outermost liquid crystal panels 3 is maintained substantially equal to that between the other adjacent liquid crystal panels (or liquid crystal cells) 3. The slide mechanism 14 may be configured by making one of the baffles (for example, the right side baffle) 12 slidable or adjustable in the horizontal direction (or the direction of disposing plural liquid crystal panels. The baffle 12 may be formed with legs (not shown) depending from its both ends. The legs are slidably received in channels 14b in the liquid crystal plate 1B. The baffle 12 may be fixed to any desired position by screws 14b. Again, a scale 16 is preferably provided on the upper surface of the liquid crystal plate 1B for proper positioning of the adjustable baffle 12. This adjustable mechanism 14 enables to reduce the surface area of the liquid crystal material 4 to be exposed to the air.

Similar to the configuration as shown in FIG. 7, this particular configuration is able to optimize consumption of the liquid crystal material 4 and thus reduce the cost by suppressing waste of the expensive liquid crystal material 4.

The provision of the rib structure comprising the ribs 11 acting as banks at both end portions of the recess 2A in the liquid crystal plate 1A or the baffle structure comprising the baffles 12 at both end portions of the recess 2B in the liquid crystal plate 1B maintains the volatile amount of the liquid crystal material 4 in the liquid crystal panel (or liquid crystal cell) 3 substantially constant regardless of locations of the liquid crystal panels (liquid crystal cells) 3 that are set to the liquid crystal plate 1A or 1B. As a result, the liquid crystal panels (or liquid crystal cells) 3 that are simultaneously fabricated have uniform liquid crystal characteristics.

Moreover, the provision of the sliding mechanism 13, 14 for sliding the ribs 11 or the baffles 12 helps to equalize the space or gap between the ribs 11 or the baffles 12 and the outermost liquid crystal panels to those between the other liquid crystal panels (or liquid crystal cells) 3 depending upon the number of liquid crystal panels (or liquid crystal cells) to be fabricated simultaneously. This enable to reduce the surface area of the liquid crystal material 4 to be exposed to the air, thereby reducing the volatile amount of the liquid crystal material 4 and in turn the fabrication cost.

Although some exemplary embodiments of the present invention as well as their modifications have been described hereinabove, it is to be noted that these exemplary embodiments are nothing but examples of the present invention. And the present invention should not be restricted only to such disclosed embodiments. It is obvious for a person having an ordinary skill in the art to make various modifications or alternations of these exemplary embodiments without departing from the scope and spirit of the present invention.

What is claimed is:

1. A liquid crystal plate having a recess for storing a liquid crystal material to be injected simultaneously into a plurality of liquid crystal panels disposed in a parallel relationship to one another by the vacuum injection method,
further comprising a raised member at both end portions of the recess, the height of the raised member being at least equal to the top surface of the liquid crystal material filled in the recess

2. A liquid crystal plate of claim 1, wherein the raised member is ribs or baffles formed in the direction parallel with the outermost liquid crystal panels.

3. A liquid crystal plate of claim 2, wherein at least one of the ribs or the baffles is made slidable with respect to the other rib or baffle for adjusting the effective size of the recess.

4. A liquid crystal injection apparatus for simultaneously injecting a liquid crystal material stored in a recess in a liquid crystal plate into a plurality of liquid crystal plates disposed in a parallel relationship to one another at a constant space therebetween,
wherein the liquid crystal plate is formed a raised member at both end portions of the recess in the direction parallel with the outermost liquid crystal panels and the height of the raised member is at least equal to the top surface of the liquid crystal material filled in the recess.

5. A liquid crystal injection apparatus of claim 4, wherein the raised member is ribs or baffles formed in the direction parallel with the outermost liquid crystal panels.

6. A liquid crystal injection apparatus of claim 5, wherein at least one of the ribs or the baffles is made slidable with respect to the other rib or baffle for adjusting the distance therebetween depending upon the number of liquid crystal panels into which the liquid crystal material is injected simultaneously.

7. A liquid crystal injection method for simultaneously injecting a liquid crystal material into a plurality of liquid crystal panels disposed in parallel with one another by dipping the plurality of liquid crystal panels into a liquid crystal material, comprising the steps of:
storing the liquid crystal material in a recess in a liquid crystal plate having a pair of raised members at the both end portions of the recess;
placing the liquid crystal plate and the plurality of liquid crystal panels in a vacuum container;
dipping injection inlets of the plurality of liquid crystal panels at the lower ends thereof into the liquid crystal material by decreasing the distance between the liquid crystal panels and the liquid crystal plate while maintaining the vacuum container in a high degree of vacuum; and
injecting the liquid crystal material into the liquid crystal panels by releasing the vacuum in the vacuum container.

8. A liquid crystal injection method of claim 7, further comprising the step of adjusting the space between the raised members of the liquid crystal plate and the outermost liquid crystal panels substantially equal to that between the other adjacent liquid crystal panels.
